(19) United States
(12) Patent Application Publication
(10) Pub. No.: US 2009/0199411 A1
(43) Pub. Date: Aug. 13, 2009

(54) SCRAPER

(76) Inventors: Gary E. van Deursen, Essex, CT (US); Richard M. O'Grady, Southington, CT (US); Daniel J. Tangari, Middletown, CT (US)

Correspondence Address: MCDERMOTT WILL & EMERY LLP, 600 13TH STREET, N.W., WASHINGTON, DC, 20005-3096, US

(21) Appl. No.: 12/363,456

(22) Filed: Jan. 30, 2009

Related U.S. Application Data
(60) Provisional application No. 61/006,751, filed on Jan. 30, 2008.

(51) Int. Cl. B26B 3/00

(52) U.S. Cl. 30/169

(57) ABSTRACT

A scraper is provided with a first member having an upper housing and a lower jaw, a second member having a lower housing and an upper jaw, and a slide latch for clamping the upper housing to the lower housing. The first and second members are pivotally connected to each other such that when the upper and lower housings are clamped together by the latch, the upper and lower jaws are clamped together to hold a blade between them. The slide latch engages an end portion of the upper and lower housings in order to clamp the jaws together. The slide latch has ridges to assist a user to push the slide latch forward to lock a blade into place and backward to release a blade. The lower housing has a cavity for storing spare blades.

### CROSS REFERENCE TO PROVISIONAL APPLICATION

This application is based upon and claims the benefit of priority from Provisional U.S. Patent Application No. 61/006,751 (Attorney docket No. 44208-039) filed on Jan. 30, 2008, the entire contents of which are incorporated by reference herein.

### TECHNICAL FIELD

The present disclosure relates to a scraper. The present disclosure has particular applicability to general purpose scrapers with replaceable blades.

### BACKGROUND

Hand scrapers have been known in the art for many years. Hand scrapers are a tool in common current use for removing floor covering such as vinyl tiles, scraping windows and walls, etc. These scrapers usually have a shaft like handle with a cross mounted blade at one end. One typical scraper, for use with a standard single-edged razor blade, is described in U.S. Pat. No. 4,558,517 which discloses a scraper hand tool that includes upper and lower housing members defining a hollow casing and an operating member axially movable therein to carry a blade between a first interior storage position, a second cutting edge protracted position, and a third blade removal and insertion position where the blade can be slid out or in to the operating member.

However, sliding the blade in or out of the blade holder is dangerous, because the user must grasp the sharp edge of the blade between fingers to change the blade.

### SUMMARY

To overcome the disadvantages discussed above, the present application is directed to a scraper that allows for easy and safe changing of the blade.

One embodiment of the disclosure is a scraper comprising a first member having an upper housing and a lower jaw, a second member having a lower housing and an upper jaw, and a slide latch for clamping the upper housing to the lower housing, wherein the first and second members are pivotally connected to each other such that when the upper and lower housings are clamped together by the latch, the upper and lower jaws are clamped together to hold a blade between them. The slide latch engages an end portion of the upper housing, and a corresponding end portion of the lower housing, opposite the upper and lower jaws, in order to clamp the jaws together.

In another embodiment, the slide latch has ridges to assist a user to push the slide latch forward to lock a blade into place and backward to release a blade.

In some embodiments, the blade is a standard scraper blade, whereas other embodiments use a single-edge razor blade, a 4-inch scraper blade or an 8-inch scraper blade.

In some embodiments, the slide latch is removable from both the upper and lower housing, whereas in other embodiments, the slide latch is not removable from one of the upper and lower housings. In another embodiment, the lower housing has a cavity for storing spare blades.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a perspective view of a scraper according to an embodiment of the present disclosure;

FIG. 2 is a top elevational view of the scraper of FIG. 1;

FIG. 3 is a perspective view of the scraper of FIG. 1;

FIG. 4 is a top elevational view of the scraper of FIG. 1;

FIG. 5a-g is a collection of sketches of the scraper of FIG. 1;

FIG. 6 is a front perspective view of a scraper according to another embodiment of the present disclosure;

FIG. 7 is a top view of the scraper of FIG. 6;

FIG. 8 is a bottom view of the scraper of FIG. 6;

FIG. 9 is a side elevational view of the scraper of FIG. 6;

FIG. 10 is a side elevational view of the scraper of FIG. 6

FIG. 11 is an elevated perspective view of a scraper according to another embodiment of the present disclosure;

FIG. 12 is a bottom perspective view of the scraper of FIG. 11; and

FIG. 13 is a side perspective view of the scraper of FIG. 11.

### DETAILED DESCRIPTION

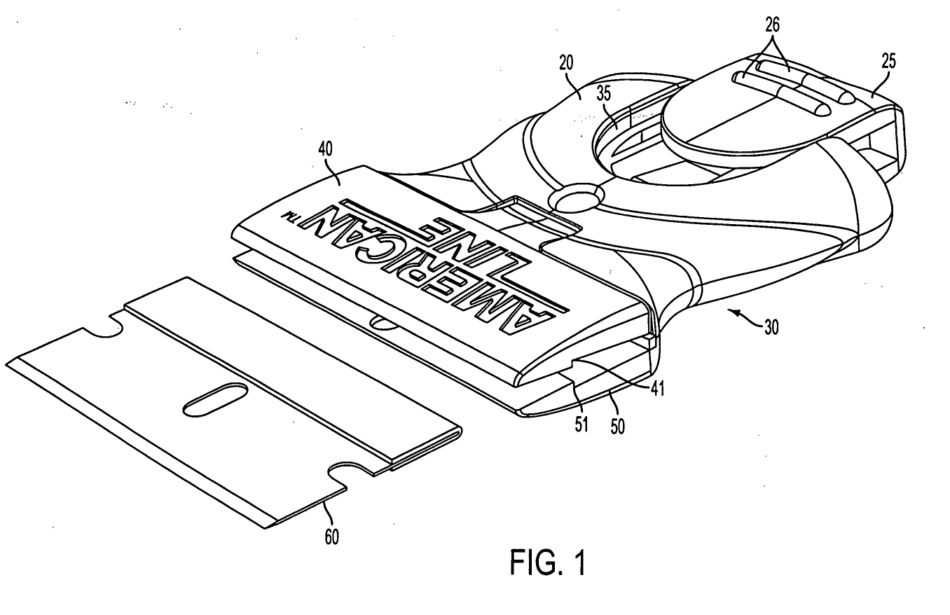

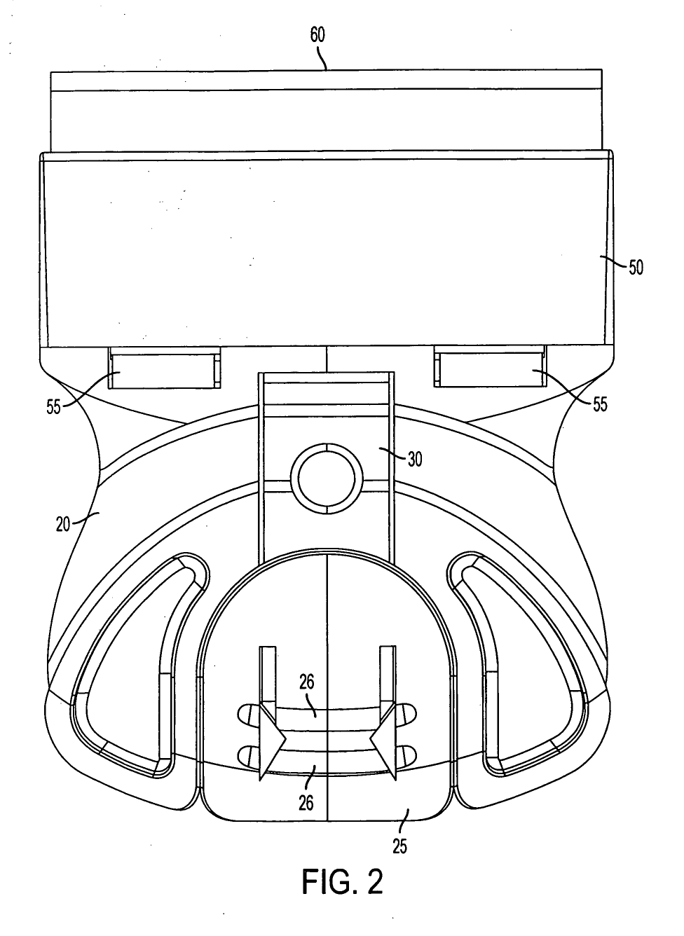

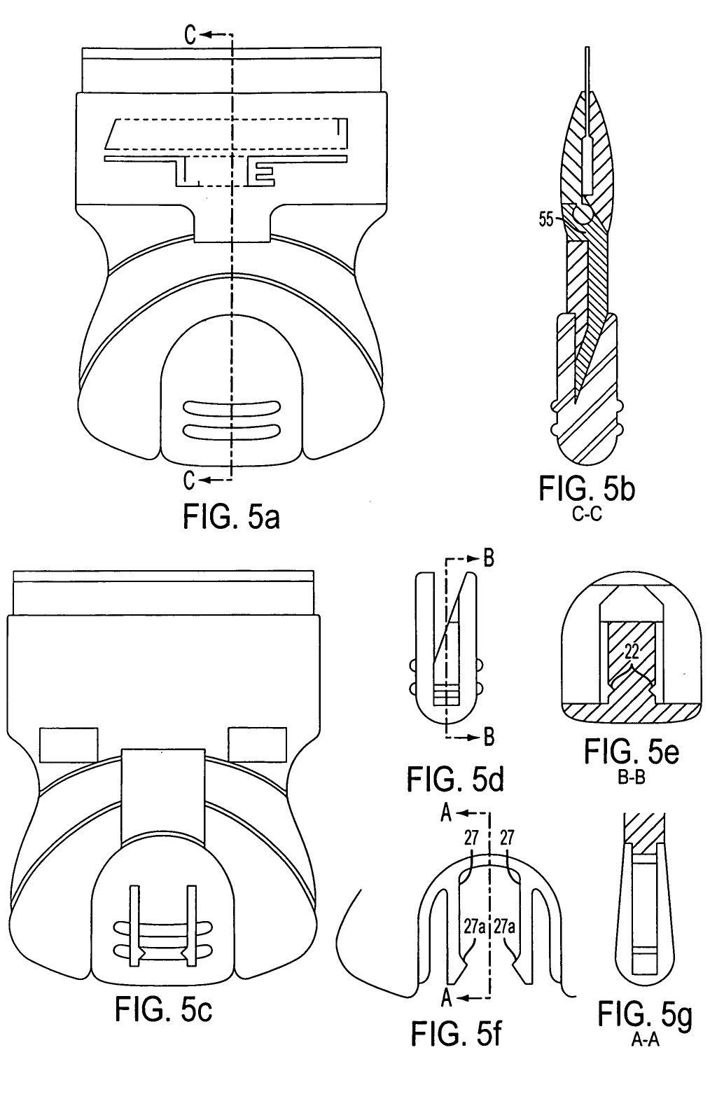

FIG. 1 shows a front perspective view of a scraper of one embodiment of the present disclosure. In the figure, a scraper 10 includes a first member having an upper housing 20 connected to a lower jaw 50 pivotally attached to a second member having a lower housing member 30 (shown in FIG. 2) connected to an upper jaw 40. A scraper blade 60 is disposed in between upper and lower jaws 40, 50. Also shown in FIG. 1, the jaws 40, 50 include step portions 41, 51 to retain the blade 60 in a secure position to prevent slippage of the blade. A slide latch 25 engages an end portion of the upper housing 20 and a corresponding end portion of the lower housing 30 opposite the upper and lower jaws to clamp the upper housing 20 to the lower housing 30, and at the same time, clamp the upper jaw 40 to the lower jaw 50. As can be seen in FIGS. 1 and 2, the upper housing 20 and lower housings 30 contain a curved groove 35 in which the slide latch 25 is attached. FIG. 2 shows the pivot points 55 by which the first member is attached to the second member. FIG. 5f shows the interior portion of the slide latch 25 which contains protruding slats 27 having ridged portions 27a which affix to a grooved section 22 of the upper and lower housings 20 and 30 to secure the slide latch 25 in place.

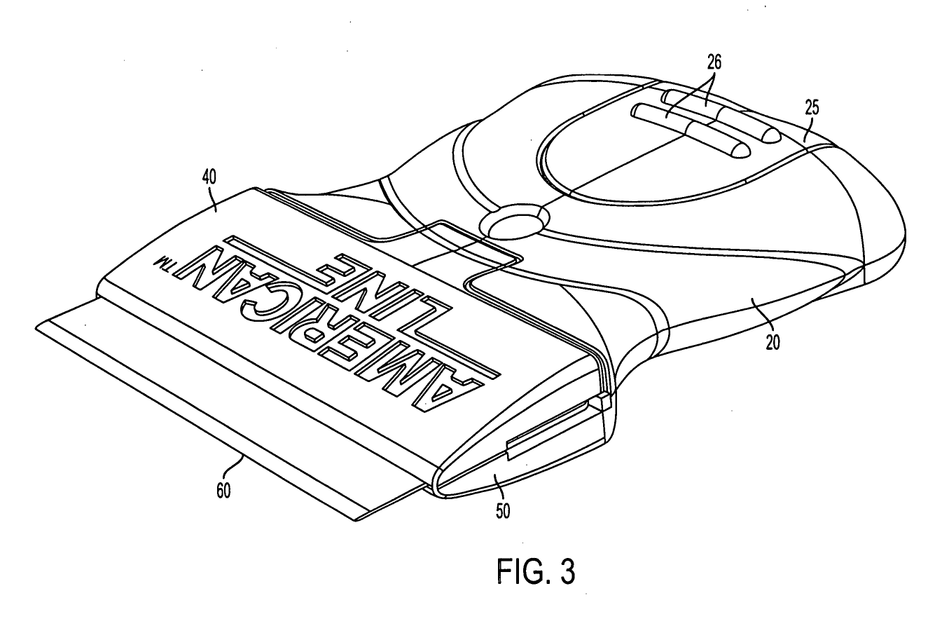

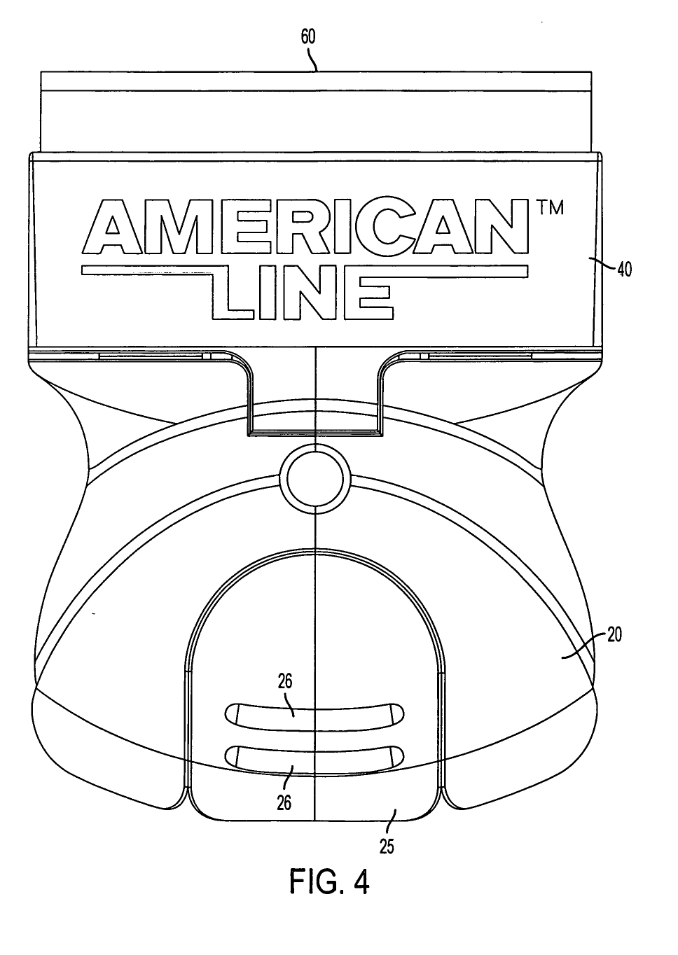

FIG. 3 shows the blade 60 clamped between upper jaw 40 and lower jaw 50 and held in place by the clamping action of slide latch 25. The blade 60 is a standard single-edge razor blade in this embodiment. In other embodiments, the blade 60 is a standard 4″ or 8″ scraper blade. Ridges 26 on slide latch 25 assist the user in pushing slide latch 25 forward to lock blade 60 into place and backward to release blade 60.

Upon removing the slide latch 25, the upper and lower jaws 40, 50 and upper and lower housings 20, 30 separate in a scissor like fashion, thereby releasing the blade 60. A side view of the scraper showing the pivot points 55 of the housings/jaws is shown in FIG. 5b.

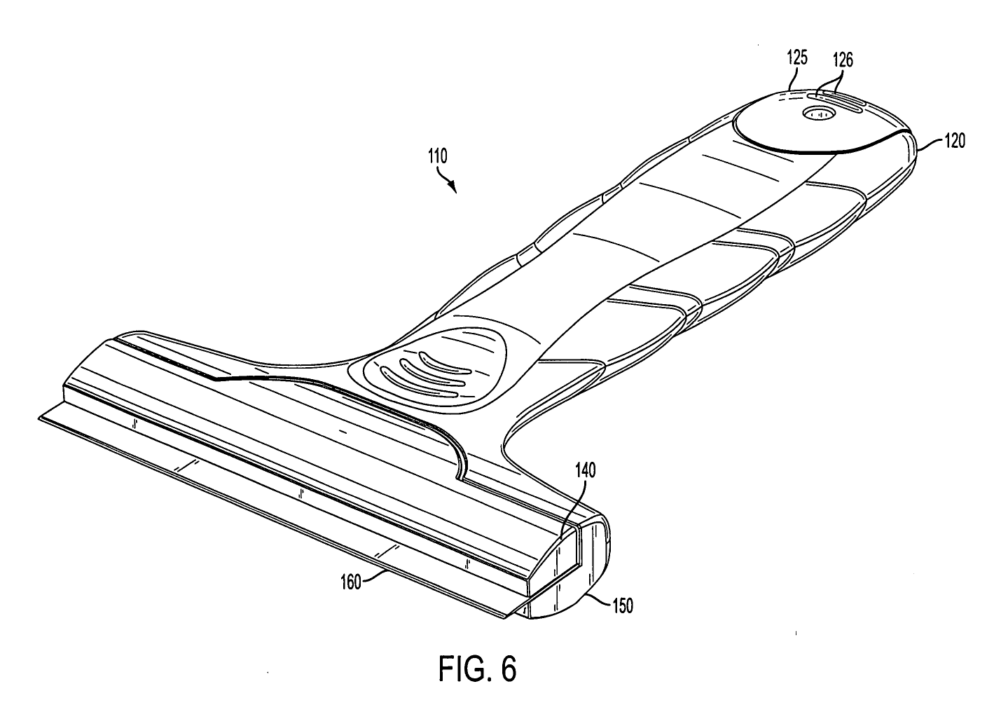

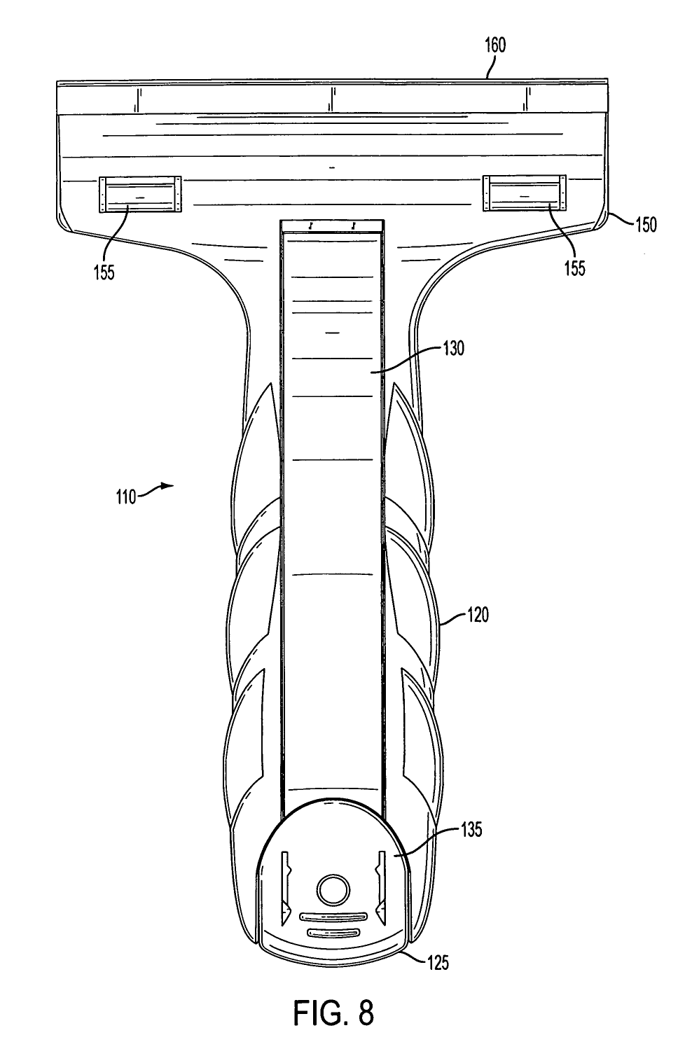

In another embodiment, best shown in FIGS. 6-10, a scraper 110 includes a first member having an upper housing 120 and a lower jaw 150, pivotally attached to a second member having a lower housing 130 (shown in FIG. 8) and a upper jaw 140.

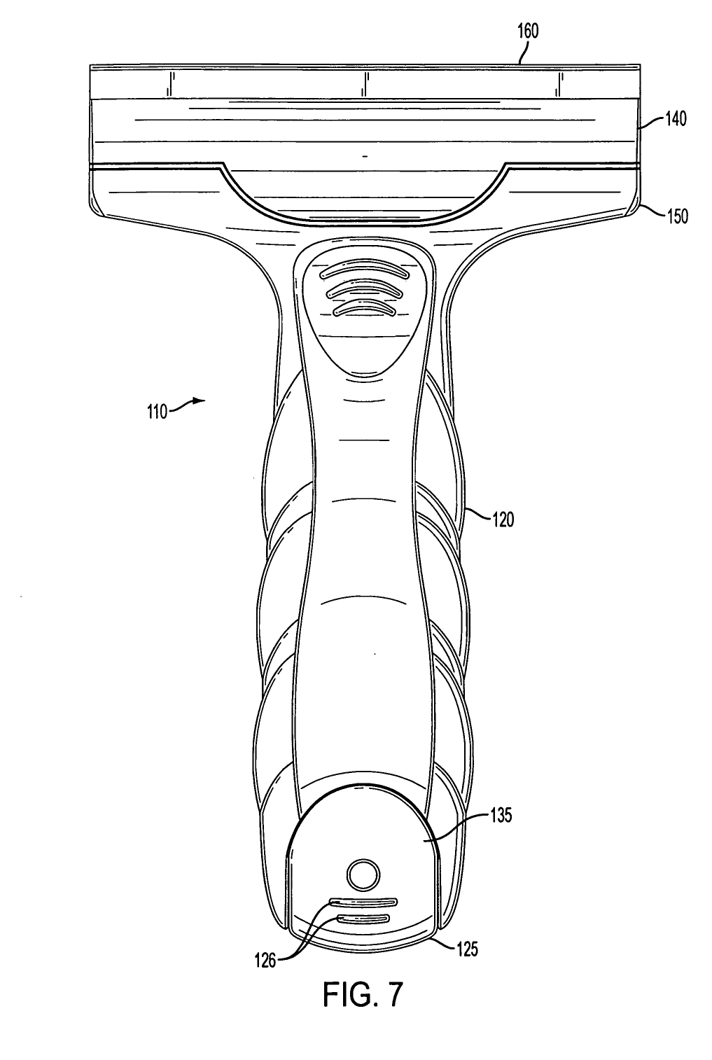

As shown in FIG. 6, scraper blade 160 is disposed in between upper jaw 140 and lower jaw 150. A slide latch 125 is used to clamp the upper housing/lower jaw 120/150 to the lower housing/upper jaw 130/140. As shown in FIGS. 7 and 8, the upper and lower housings 120 and 130 contain a curved groove 135 in which the slide latch 125 is attached. The interior portion of the slide latch 125 contains protruding slats 127 having ridged portions 127a which affix to a grooved section 122 of the upper and lower housings 120 and 130 to secure the slide latch 125 in place.

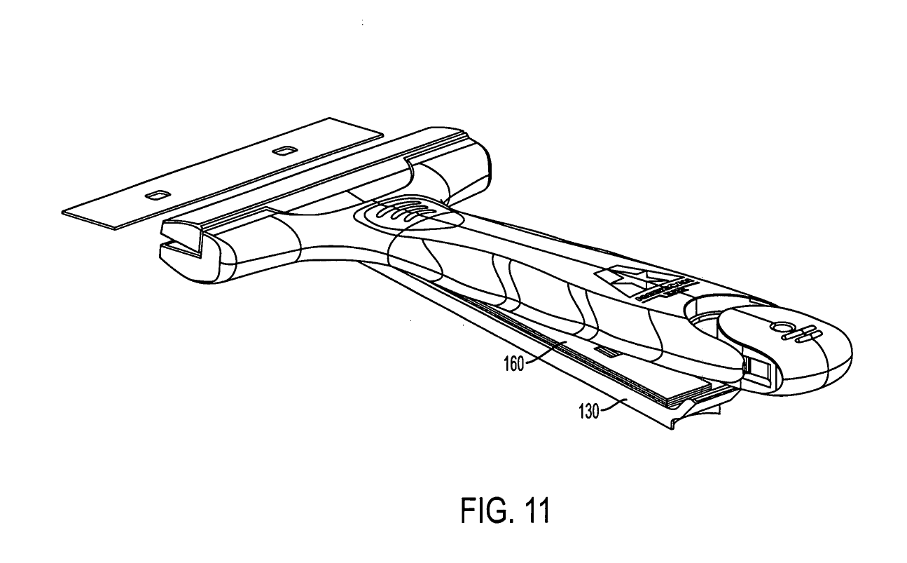

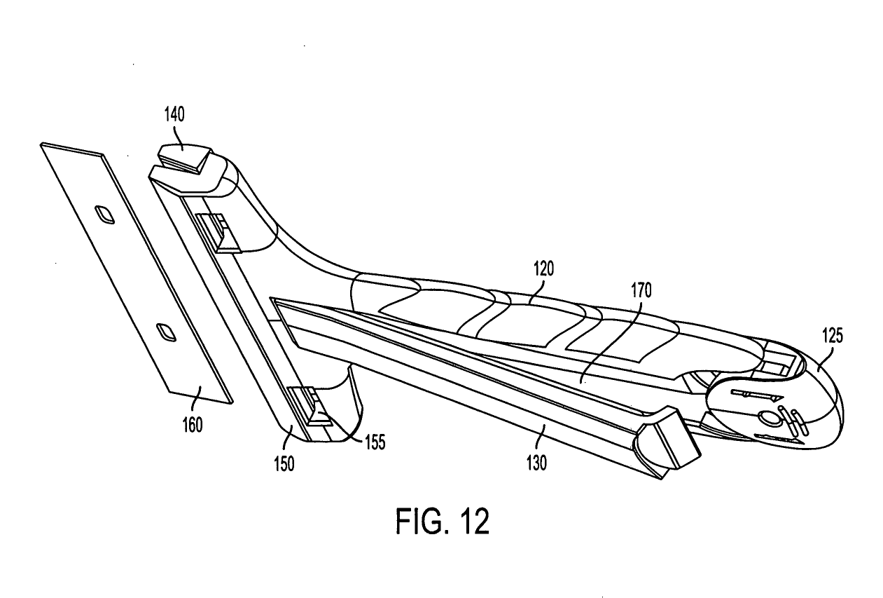

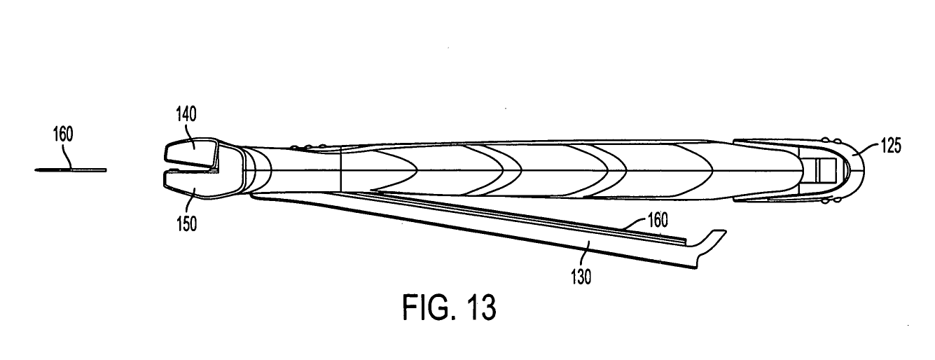

The slide latch 125 is attached to the upper housing 120 such that it is not removed when slid away from the blade end of the scraper to allow for the blade 160 to be removed (see, FIGS. 11-13). In this embodiment, the blade is a 4″ scraper blade. When the slide latch 125 is retracted, the first and second members separate in a scissor like fashion at the pivot points, thereby releasing the blade 160. The pivot points 155 of the housings/jaws and the bottom housing 130 are shown in FIG. 8, a bottom view of the scraper.

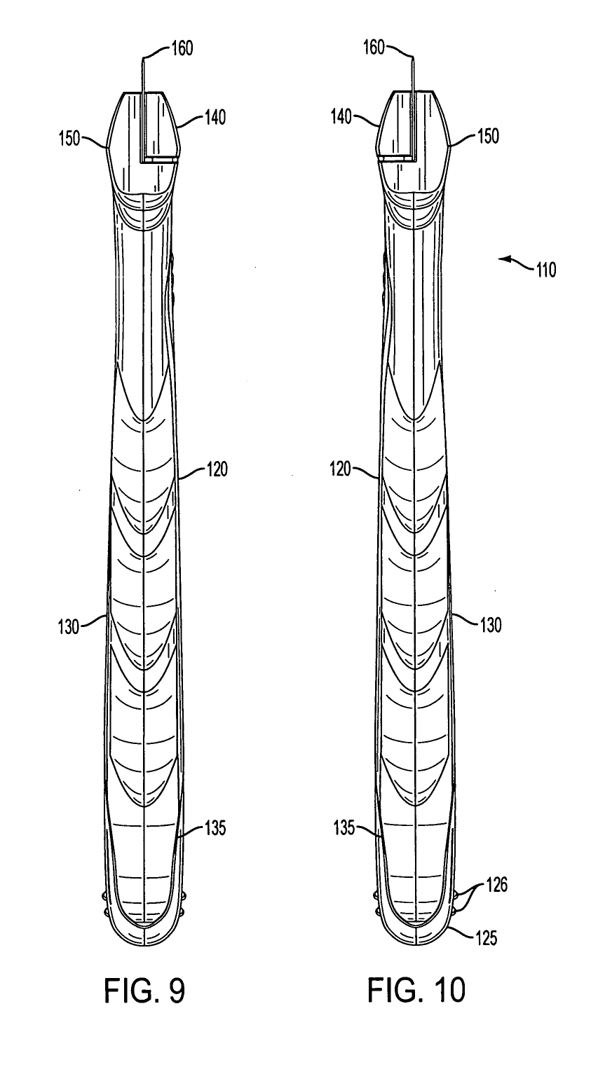

FIGS. 9 and 10 show side views of the scraper in a clamped position. As can be seen, in the clamped position, the upper jaw 140 fits in a 90 degree cutaway portion of the larger lower jaw 150. In this configuration, when a blade 160 is clamped into place, the dull back end of the blade will abut the horizontal edge of the lower jaw 150. This provides an added degree of stability to the blade during use. As the scraper 110 is used, the blade 160 is pushed toward the opposing end of the scraper 110. Since the blade 160 abuts the lower jaw 150, no displacement of the blade in a lateral direction will occur.

The scraper also contains a cavity 170 to hold spare blades. As is shown in FIGS. 11-13, when the blade is unclamped thereby allowing the first member to separate at the pivot point 155 from the second member, the lower housing 130 separates from the upper housing 120 to reveal a cavity 170. In this cavity 170, spare blades 160 may be kept for future use.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

What is claimed is:

1. A scraper comprising:
a first member comprising an upper housing and a lower jaw;
a second member comprising a lower housing and an upper jaw;
a slide latch for clamping the upper housing to the lower housing,
wherein the first and second members are pivotally connected to each other such that when the upper and lower housings are clamped together by the latch, the upper and lower jaws are clamped together to hold a blade between them.

2. The scraper of claim 1, further comprising ridges on slide latch to assist a user to push the slide latch forward to lock a blade into place and backward to release the blade.

3. The scraper of claim 1, wherein the blade is a standard scraper blade.

4. The scraper of claim 1, wherein the blade is a standard single-edge razor blade.

5. The scraper of claim 1, wherein the slide latch engages an end portion of the upper housing, and a corresponding end portion of the lower housing, opposite the upper and lower jaws.

6. The scraper of claim 1, wherein the slide latch is removable from both upper and lower housings.

7. The scraper of claim 1, wherein the slide latch is not removable from one of the upper and lower housings.

8. The scraper of claim 1, wherein one of the upper and lower jaws comprises an edge located on an inner face of one of the upper and lower jaws, wherein a dull portion of the blade opposite a cutting edge of the blade abuts the edge when the upper and lower jaws are clamped together.

9. The scraper of claim 1, wherein the lower housing further comprises a cavity for holding a blade located on the inner portion of the lower housing.
